(19) United States
(12) Patent Application Publication
(10) Pub. No.: US 2023/0263224 A1
(43) Pub. Date: Aug. 24, 2023

(54) Heating Apparatus for an Aerosol Generating Device

(71) Applicant: JT International SA, Geneva (CH)

(72) Inventors: Alec Wright, Guildford (GB); Andrew Rogan, Forres (GB)

(73) Assignee: JT International SA, Geneva (CH)

(21) Appl. No.: 18/005,451

(22) PCT Filed: Jul. 13, 2021
(86) PCT No.: PCT/EP2021/069532

§ 371 Date: Jan. 13, 2023

(30) Foreign Application Priority Data
Jul. 17, 2020 (EP) 20186581.3

(51) Int. Cl. A24F 40/46; H05B 3/24; A24F 40/20

(52) U.S. Cl. CPC A24F 40/46; H05B 3/24; A24F 40/20; H05B 2203/005; H05B 2203/016

(57) ABSTRACT

An aerosol generating device is described. The aerosol generating device includes a heating chamber comprising an opening arranged to receive a consumable; a heating apparatus for heating the consumable; wherein the heating apparatus comprises two or more heating segments and at least one insulator; 5 the two or more heating segments are arranged longitudinally along a length of the heating chamber and are configured to be independently heated; and the at least one insulator is arranged between adjacent heating segments. In this way, the device is capable of efficiently heating consumables of different shapes and sizes.

The present invention relates to a heating apparatus for an aerosol generating device.

### BACKGROUND

Known aerosol generating devices, such as e-cigarettes and tobacco vapour products, often use a heating apparatus to heat an aerosol generating medium in order to generate an aerosol or vapour, for inhalation by a user. The aerosol generating medium is commonly inserted into a heating chamber of the device in the form of a consumable plug or cartridge. Different types of consumables are available and the sizes of these consumables may vary; however, many existing aerosol generating devices are restricted to receiving specific consumables due to differences in the dimensions of the consumables, the heating chamber, and the heating apparatus. Generally, aerosol generating devices are configured to accept a single type of consumable of a single size. Due to these specific configurations, there is a problem that these devices cannot accept different types of consumables and effectively heat them. It is therefore an aim of the present invention to provide a heating apparatus for an aerosol generating device that can efficiently heat consumables of different shapes and sizes.

### SUMMARY

According to an aspect of the invention, there is provided an aerosol generating device comprising: a heating chamber comprising an opening arranged to receive a consumable; a heating apparatus for heating the consumable; wherein the heating apparatus comprises a heating blade comprising two or more heating segments and at least one insulator; the two or more heating segments are arranged longitudinally along a length of the heating chamber and are configured to be independently heated; and the at least one insulator is arranged between adjacent heating segments.

Providing the heating apparatus with multiple heating segments that can be independently heated allows the apparatus to only heat those segments which are arranged or configured to efficiently heat the consumable.

The heating segments that are not selected to be directly heated, i.e. activated, in order to heat a consumable received in the heating chamber, are herein referred to as unused heating segments (or unused segments). Typically, this is because the unused segment is not able to heat the consumable efficiently. For example, an unused heating segment may not be in contact with the consumable, or only a small portion of the consumable is in contact with the unused heating segment. A required heating segment (or required segment) refers to a heating segment that has been selected to be directly heated in order to heat a consumable held in the heating chamber and is any heating segment that is not an unused segment.

Arranging an insulator between the heating segments reduces the heat conduction between the segments. Any heat transferred from a required heating segment to an unused segment is wasted energy. Therefore, as they reduce the transfer of heat between segments, the insulator increases the effectiveness and efficiency of the heating apparatus; increasing device battery life and improving the user experience.

In some examples of the invention, the heating chamber is tubular shaped. This may facilitate more even heating of a consumable received in the heating chamber.

The aerosol generating device could equally be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating medium.

The term “consumable” refers to an aerosol generating medium, a cartridge or other container comprising an aerosol generating medium, or any other component suitable for delivering an aerosol generating medium into the device such that an aerosol may be generated.

Preferably, the heating apparatus extends longitudinally along the heating chamber, wherein the heating segments are axially aligned sections of the heating apparatus. More preferably, the heating apparatus is also arranged through a central longitudinal axis of the heating chamber.

Preferably, each of the heating segments are arranged such that the longitudinal axis of each of the heating segments is substantially parallel to the longitudinal axis of the heating chamber.

Preferably, the sum of the length of required heating segments and insulators adjacent to the required heating segments is substantially equivalent to the length of a substrate portion of the received consumable. More preferably, the sum of the length of the required heating segments and insulators adjacent to the required heating segments is substantially equivalent to the length of the substrate portion of the received consumable minus the length of the insulator furthest from the opening. In this way, the area of heating segments contacting the substrate relative to the area of insulators contacting the substrate is increased, thereby improving heating efficiency of the substrate portion of the consumable.

Optionally, the device may comprise three or more heating segments arranged along the length of the heating chamber; and a plurality of insulators comprising a first insulator arranged between a first pair of adjacent heating segments and a second insulator arranged between a second pair of adjacent eating segments.

Dividing the heating apparatus into a larger number of heating segments, which can be independently heated, allows for an improved level of control over the heating of a consumable. Furthermore, when the heating apparatus is divided into a larger number of heating segments, the length of a given consumable will more precisely match the area occupied by an integral number heating segments.

The first insulator may have different insulating properties to the second insulator. In this way, it is possible to tune the insulating properties according to the design of the heating apparatus, saving manufacturing resources and reducing the size of the apparatus. For example, if a first insulator is between two powerful or large heating segments then this first insulator should have stronger insulating properties than a second insulator between two less powerful or smaller heating segments. In another example, specific heating segments may be heated less frequently than other heating segments and so may not require a nearby insulator with as high insulating properties (as the insulators nearby the frequently heated heating segments).

The heating blade may be configured to pierce the consumable when received in the heating chamber.

In this way, when a consumable is in the heating chamber, the heating blade may heat the consumable from the interior. Furthermore, the heating blade may secure or assist securing the consumable within the heating chamber.

The heating blade may comprise a piercing end directed towards the opening of the heating chamber.

The piercing end of the heating blade is directed towards the opening of the heating chamber and narrows towards the opening. The piercing end facilitates the insertion of the consumable into the heating chamber. This may be through piercing a hole in the consumable for (at least a portion of) the heating blade to pass into or to ease inserting the heating blade into a slot already present in the consumable.

In some examples, the heating apparatus may comprise a heating element that extends along an inner or outer surface of the heating chamber. For example, the heating element may be a thin film heating element which is wrapped around an inner or outer surface of the heating chamber. Such an apparatus may evenly heat a consumable, received in the heating chamber, from its exterior.

The at least one insulator may comprise at least one hole in the heating apparatus. The air occupying the hole(s) has lower thermal conductivity than the heating segments and so does not allow heat to pass between segments as readily. The shape, size, number, and arrangement of the hole(s) may be adjusted to determine the insulating properties of the at least one insulator. Implementing at least one hole as the insulator reduces the weight of the heating apparatus and does not require any additional components to be incorporated into the apparatus.

The at least one insulator may comprise an insulating material. The insulating material has a lower thermal conductivity than the heating segments and so does not allow heat to pass between segments as readily. The type of material used as the insulating material and the quantity, size, and shape of the insulating material may be modified to determine the insulating properties of the at least one insulator. For example, the insulating material may be polyimide. Polyimide materials are lightweight, flexible, and resistant to heat and chemicals which makes it a good choice for an insulating material in a hand held aerosol generating device. In some examples, a single type of material is used as the insulating material in all of the insulators. However, in other examples, multiple different types of materials may be used as the insulating material.

The heating apparatus may further comprise a support element extending along the length of the heating apparatus and arranged to support the heating segments. The support element may increase the structural integrity of the heating apparatus and so extend its durability. The support element may comprise an insulating material. In this way, heat transfer through the support element may be reduced or prevented. The support element may be a central core within the heating apparatus, with other components of the heating apparatus, such as the heating segments, arranged around it. This provides the structural, and optionally insulating, benefits discussed above while allowing for a compact heating apparatus.

The at least one insulator may comprise a plurality of insulating elements. The term insulating element may refer to a hole or insulating material as described above, or another element with thermal insulation capabilities. For example, the at least one insulator may include an insulating material with holes arranged throughout the insulating material. That is, in some embodiments, each insulator of the at least one insulator(s) may include a plurality of insulating elements. A heating apparatus including such an insulator would benefit from the advantages associated with each type of insulating element and optimise efficient heating of a consumable.

The aerosol generating device may further comprise two or more conducting tracks arranged on the heating apparatus and configured to power the two or more heating segments.

Preferably, each conducting track powers a single heating segment. Having individual conducting tracks power individual heating segments allows the conducting tracks to be arranged further apart from each other, reducing unwanted heat transfer through the tracks.

The conducting tracks may pass through the at least one insulator. In this way, unwanted heat transfer through the conducting tracks is reduced. In some examples of the invention, the conducting tracks may be surrounded by an insulating element and/or the support element to reduce heat transfer through the tracks.

The aerosol generating device may further comprise a base plate arranged within the heating chamber; wherein the base plate is moveable along the heating chamber relative to the heating apparatus.

The base plate may define the length of the heating chamber and, in some examples, be used to determine which heating segments are required heating segments. Optionally, the base plate comprises an insulating element to prevent unwanted heat conduction from powered heating segments and to shield other regions of the aerosol generating device from the heating apparatus and chamber.

The heating apparatus may extend through a plate opening in the base plate. In this way, the heating apparatus acts as a guide for the base plate as it moves along the heating chamber and heating apparatus.

### BRIEF DESCRIPTION OF THE DRAWINGS

Examples of the present invention will now be described in detail with reference to the accompanying drawings, in which:

FIG. 1 is a schematic view of an aerosol generating device according to an example of the present invention;

FIG. 2 is a schematic view of a heating apparatus for an aerosol generating device according to an example of the present invention;

FIG. 3 is a schematic view of a heating apparatus for an aerosol generating device according to an example of the present invention;

FIG. 4 is a schematic view of a heating apparatus for an aerosol generating device according to an example of the present invention;

FIG. 5 is a schematic view of a heating apparatus for an aerosol generating device according to an example of the present invention;

FIG. 6 is a schematic view of an aerosol generating device according to an example of the present invention; and

FIG. 7 is a schematic view of an aerosol generating device according to an example of the present invention.

### DETAILED DESCRIPTION

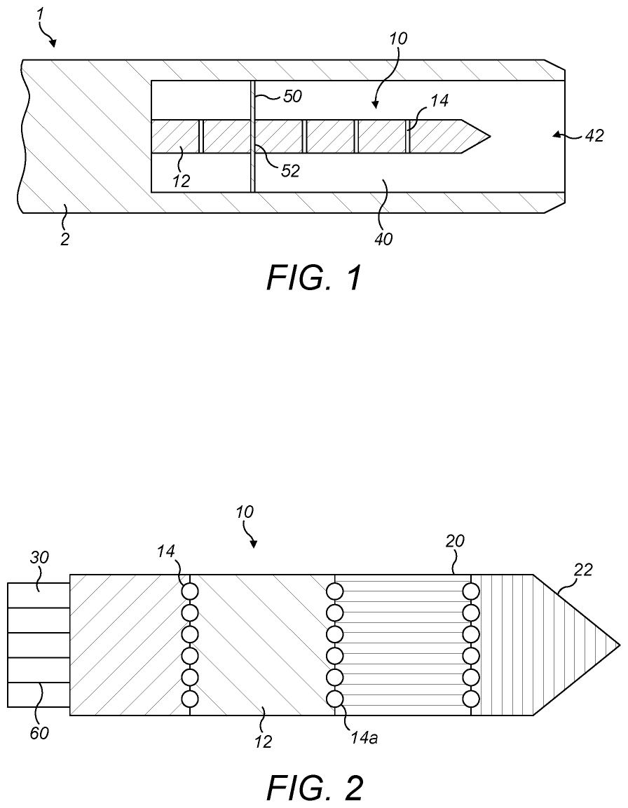

The present invention provides a heating apparatus 10 for an aerosol generating device 1 with improved heating efficiency. Several examples of the heating apparatus 10 are shown in FIGS. 1 to 7 and described below.

FIG. 1 schematically illustrates a portion of an aerosol generating device 1 according to the present invention. The device 1 comprises a housing 2 and tubular heating chamber 40 arranged within the housing 2 and configured to hold a consumable comprising an aerosol generating medium. The heating chamber 40 includes an opening 42 through which the consumable may be received.

A heating apparatus 10 is arranged within the heating chamber 40 and comprises a heating blade 20 configured to pierce and/or pass into the consumable when it is introduced to the heating chamber 40 such that, in use, a consumable is heated from its interior. A piercing end 22 of the heating blade 20 is directed towards the opening of the heating chamber 40 to facilitate the interaction between the heating blade 20 and the consumable. The heating apparatus 10 comprises heating segments 12 arranged longitudinally along the length of the heating chamber 40, with each pair of heating segments 12 being separated by an insulator 14. The heating segments 12 may each be heated independently from one another and are connected to a power source (not shown) that supplies energy to the heating segments 12 when activated. This allows the heating apparatus 10 to efficiently heat consumables of different sizes as only heating segments 12 that are required for a specific consumable will be activated. Typically, the heating segments 12 are electrical conductors that generate heat using resistive heating such as wire heaters, mesh heaters, and film heaters.

The insulators 14 separating pairs of heating segments 12 reduce the conduction of heat between heating segments 12. Any heat transferred from a required heating segment to an unused heating segment is wasted energy which could have been used to power the required heating segments and more effectively heat the consumable. Therefore, the insulators 14 improve the effectiveness and efficiency of the heating apparatus 10.

In this example, the device 1 further comprises a base plate 50 arranged within the heating chamber 40 and configured to move along the heating chamber 40, relative to the heating apparatus 10, in order to define the length of the heating chamber 40. The heating apparatus 10 extends through a plate opening 52 in the base plate 50 and so further acts as a guide for the base plate 50 as it moves relative to the heating apparatus 50. In use, when a consumable has been introduced to the heating chamber 40, the base plate 50 moves along the heating chamber 40 until it is in contact with the consumable. In some examples of the invention, the base plate 50 comprises insulating material or an insulating element to prevent unwanted heat conduction from activated heating segments 12 and to shield the rest of the device 1 from the higher temperatures on the consumable side of the base plate 50. In some examples of the invention, the location of the base plate 50, relative to the heating apparatus 10, is used to determine which heating segments 12 are required to heat a consumable. In other examples, the required heating segments 12 may be determined through other means such as a detectable identifier in the consumable, a sensor(s) on the heating apparatus 10 sensing the size and/or location of the consumable, or any other suitable means.

FIG. 2 schematically illustrates a heating apparatus 10 for an aerosol generating device 1 according to the present invention. Similarly to the example in FIG. 1, the heating apparatus 10 comprises a heating blade 20 with piercing end 22 and heating segments 12 arranged along the length of the heating blade 20. Insulators 14 are arranged between adjacent heating segments 12 to prevent heat conduction between the heating segments 12. In this example, conducting tracks 60 are arranged on the heating apparatus 10 and connected to the heating segments 12 in order to supply power to the heating segments 12 from a power source. The heating apparatus 10 further comprises a support element 30 extending along the length of the heating apparatus 10 and is used to increase the structural integrity of the heating apparatus 10.

The support element 30 may be a framework comprised of multiple parts arranged throughout the heating apparatus 10, acting as a skeletal structure for other components such as the heating segments 12. Alternatively, the support element 30 may be a central core within the heating apparatus 10 and with the other components arranged around it. Increasing the structural integrity of the heating apparatus 10, for example by incorporating the support element 30, will prolong the service life of the heating apparatus 10 as it may be repeatedly used with a large number of different consumables.

If a support element 30 is included in the heating apparatus 10, it is important that the heating segments 12 are arranged on the exterior of the support element 30 so as to efficiently heat the consumable. Preferably, in all examples of the invention, the heating segments 12 are the outermost layer of the heating apparatus 10.

Depending on the nature and implementation of the heating apparatus 10, a support element 30 may not be included as the other components of the heating apparatus 12 (such as the heating segments 12 and insulators 14) provide the appropriate structural integrity.

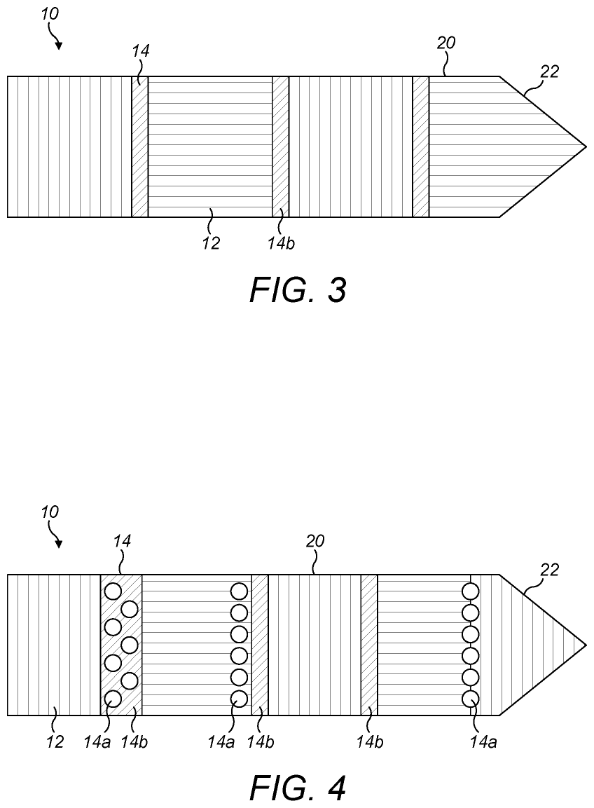

In the example of FIG. 2, the insulators 14 comprise holes 14a arranged between adjacent heating segments 12. The air occupying the holes 14a has lower thermal conductivity than the heating segments 12 and so does not allow heat to pass between heating segments 12 as readily. In some examples the holes 14a may only penetrate through the heating segment 12 layer of the apparatus 10 while in other examples the holes 14a may pass through additional components, such as the support element 30, or the whole heating apparatus 10. The size and arrangement of the holes 14a (e.g. a regular array, irregular array, or random array) can be chosen to determine the insulating properties provided along with the structural integrity of the heating apparatus 10. Having the insulators 14 comprise holes 14a has other associated benefits such as reducing costs and increasing the ease of manufacture as fewer materials and types of materials are required. Using holes 14a also reduces the weight of the heating apparatus 10 which may be appealing to users of an aerosol generating device including the heating apparatus 10. Different types of insulators 14 are described later in relation to FIGS. 3, 4 and 5.

Though the example shown in FIG. 2 comprises four heating segments 12, other heating apparatus 10 according to the invention may comprise any number (greater than two) of heating segments 12. The heating segments 12 shown in FIG. 2 are all also substantially the same size and shape (except for the segment 12 that incorporates the piercing end 22 of the heating blade 20). However, this is not required and the dimensions of the heating segments 12 may be designed to correspond to the consumables intended for use with the heating apparatus 10. For example, another heating apparatus 10 may have a large number of small heating segments 12, with each heating segment separated by an insulator 14, in order to increase the range of different sized consumables that can be efficiently heated by the heating apparatus 10.

In the heating apparatus 10 shown in FIG. 2, individual conducting tracks 60 are provided for each heating segment 12 in order to transfer power to the corresponding segment 12. In another example there may be provided a single main conducting track 60 that splits along the length of the heating apparatus 10 so that individual heating segments 12 may be independently powered. Preferably, a conducting track 60 will not contact any of the heating segments 12 except for the individual heating segment 12 being powered by that conducting track 60. This helps to insulate the heating segments 12 by avoiding heat being transferred between heating segments 12 by means of the conducting tracks 60. In some examples of the invention, the conducting tracks 60 may be surrounded or partially surrounded by an insulator 14 when nearby other heating segments 12. The conducting tracks 60 may also be arranged within the support element 30.

FIG. 3 schematically illustrates another heating apparatus 10 for an aerosol generating device 1 according to the present invention. The heating apparatus 10 of FIG. 3 is similar to that shown in FIG. 2 however the insulators 14 comprise insulating material 14b instead of holes 14a. The insulating material 14b has a lower thermal conductivity than the heating segments 12 and so does not allow heat to be transferred between segments 12 as readily as when there is no insulator 12. The type of material used as the insulating material 14b may be chosen in order to determine the insulating properties of the insulator 14. The quantity, size, and shape of the insulating material 14b may also be modified to determine the resulting insulating properties. The insulating material 14b may comprise polyimide or other high temperature plastics, ceramic, fiberglass, or an epoxy resin.

Incorporating insulating material 14b into the insulators 14 reduces heat conducted between heating segments 12 while increasing the structural integrity of the heating apparatus 10. If a support element 30 is included in the heating apparatus 10, the insulators 14 may also be attached to the support element 30 to increase the structural integrity of the apparatus 10, though this also depends on the type and the arrangement of the insulator 14. For example, when the insulator comprises an insulating material 14b then the insulator can be attached to the support element 30. However, if the insulator 14 comprises a hole 14a then this may not be able to be attached to the support element 30. In addition, the support element 30 may comprise insulating material 14b to prevent heat being transferred through the support element 30.

In some examples of the invention, each insulator 14 in a heating apparatus 10 will have the same insulating properties as the other insulators 14 in the heating apparatus 10. However, in some examples, different insulators 14 in the same heating apparatus 10 may have different insulating properties to one another. This allows heat conduction throughout the heating segments 12 to be precisely controlled according to the need. For example, the heating segment 12 including the piercing end 22 of the heating blade 20 may be a required segment for many more types of consumables than the heating segment 12 furthest from the piercing end 22. Therefore, the heating segment 12 including the piercing end 22 will be heated more often and so the insulator 14 adjacent to this segment 12 may be a better thermal insulator than the insulator 14 to the heating segment 12 furthest from the piercing end 22.

Though the previous examples show heating apparatus 10 that only use a single type of insulator 14 (e.g. holes 14a or an insulating material 14b), different types of insulators 14 may be combined and used together in the same heating apparatus 10 as shown in FIG. 4.

FIG. 4 schematically illustrates a heating apparatus 10 for an aerosol generating device 1 according to the present invention. As in the previous examples, the heating apparatus 10 comprises a plurality of heating segments 12 where adjacent segments 12 are separated by an insulator 14. The heating apparatus 10 comprises different types and configurations of insulating elements (where a hole 14a and an insulating material 14b are both types of insulating elements) or insulators 14. More specifically, an insulator 14 comprises an insulating material 14b with holes 14a arranged throughout the insulating material 14b. Another insulator 14 comprises an insulating material 14b and a row of holes 14a (in the heating segment 12) adjacent to the insulating material 14b. These are examples of combining different types of insulators 14 and more are possible that are not shown.

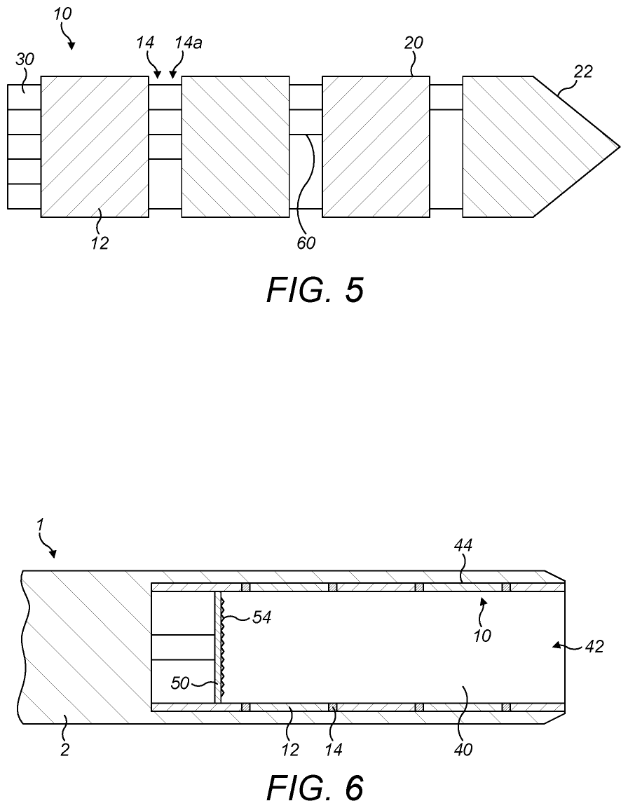

FIG. 5 schematically illustrates a heating apparatus 10 for an aerosol generating device 1 according to the present invention. In the example of FIG. 5, each insulator 14 is a single hole 14a that defines a gap between adjacent heating segments 12. The size of the insulators 14 has been emphasised to show how the support element 30 is used as the central core of the heating apparatus 10 with the heating segments 12 arranged around it. Similarly, the conducting tracks 60 used to power the heating segments 12 can be seen in the gaps between segments 12.

FIG. 6 schematically illustrates a portion of an aerosol generating device 1 according to the present invention. As in the device 1 of FIG. 1, the device 1 comprises a housing 2 and heating chamber 40, with an opening 42, arranged within the housing 2 and configured to hold an aerosol generating consumable. The heating apparatus 10 comprises heating segments 12 arranged longitudinally along the length of the heating chamber 40. The heating segments 12 are disposed on the inner surface 44 of the heating chamber 40 such that, in use, a consumable is heated from its exterior. The heating segments 12 may cover the full inner surface 44 or may be arranged in strips or patterns across the inner surface 44. Insulators 14 are arranged between adjacent heating segments 12 to reduce the conduction of heat between heating segments 12 and may be any type of insulator 14 described above. Additional insulators (not shown) may be provided between the heating apparatus 10 and the inner surface 44 of the heating chamber 40 to further reduce wasted energy and shield the housing 2 and device 1 from generated heat.

In some examples, the device 1 further comprises a base plate 50 arranged within the heating chamber 40 and configured to move along the heating chamber 40, relative to the heating apparatus 10 as described in relation to FIG. 1, though the base plate 50 will not include a plate opening 52 if there is no heating blade 22.

The base plate 50 may comprise structures such as plate grips 54 arranged to interact with and secure a consumable that has been received in the heating chamber 40.

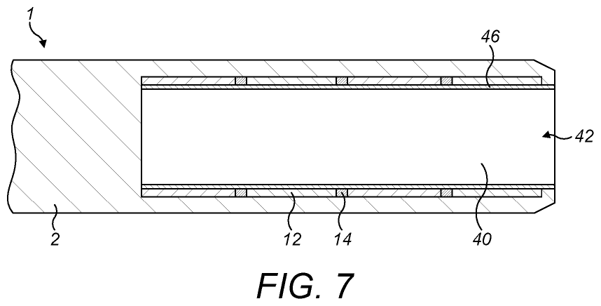

FIG. 7 schematically illustrates a portion of an aerosol generating device 1 according to the present invention. Similar to the other devices described above, the device 1 comprises a housing 2 and tubular heating chamber 40, with an opening 42, arranged within the housing 2 and configured to hold an aerosol generating consumable. The heating apparatus 10 is external to the heating chamber 40 and comprises at least one thin film heating element wrapped around an outer surface 46 of the heating chamber 40.

The thin film heating element typically comprises a flexible heating track on a flexible backing film, where the heating track follows a circuitous path to cover a heating segment 12 of the thin film heating element. In some examples, a single thin film heating element may have multiple heating tracks that form separate heating segments 12 than can be independently heated. In other examples, the heating apparatus 10 may comprise multiple thin film heating elements where each element comprises a single heating track and is an individual heating segment 12 than can be independently heated.

Regardless of how the thin film heating element is implemented, the heating segments 12 are separated by insulators 14, in order to reduce the conduction of heat between segments 12, such that the heating apparatus 10 comprises alternating rings of heating segments 12 and insulators 14 wrapped around the outer surface 46 of the heating chamber 40 (i.e. hollow cylindrical heating segments 12 and insulators 14). Additional insulators (not shown) may be provided in a layer around the heating apparatus 10, on the opposite side of the heating apparatus 10 to the heating chamber 40, to further reduce wasted energy and shield the rest of the device 1 from generated heat. A base plate 50 is not shown in the device 1 of FIG. 7 but may be included in similar manner to that described above in reference to FIG. 6.

1. An aerosol generating device comprising:
a heating chamber comprising an opening arranged to receive a consumable;
a heating apparatus for heating the consumable;
wherein the heating apparatus comprises a heating blade comprising two or more heating segments and at least one insulator;
the two or more heating segments are arranged longitudinally along a length of the heating chamber and are configured to be independently heated; and
the at least one insulator is arranged between adjacent heating segments.

2. The aerosol generating device of claim 1, comprising three or more heating segments arranged along the length of the heating chamber; and
a plurality of insulators comprising a first insulator arranged between a first pair of adjacent heating segments and a second insulator arranged between a second pair of adjacent heating segments.

3. The aerosol generating device of claim 2, wherein the first insulator has different insulating properties than the second insulator.

4. The aerosol generating device of claim 1, wherein the heating blade is configured to pierce the consumable when received in the heating chamber.

5. The aerosol generating device of claim 4, wherein the heating blade comprises a piercing end directed towards the opening of the heating chamber.

6. The aerosol generating device of claim 1, wherein the at least one insulator comprises at least one hole in the heating apparatus.

7. The aerosol generating device of claim 1, wherein the at least one insulator comprises an insulating material.

8. The aerosol generating device of claim 7, wherein the insulating material is polyimide.

9. The aerosol generating device of claim 1, wherein the heating apparatus further comprises a support element extending along the length of the heating apparatus and arranged to support the two or more heating segments.

10. The aerosol generating device of claim 9, wherein the support element comprises an insulating material.

11. The aerosol generating device of claim 1, wherein the at least one insulator comprises a plurality of insulating elements.

12. The aerosol generating device of claim 1, further comprising:
two or more conducting tracks arranged on the heating apparatus and configured to power the two or more heating segments.

13. The aerosol generating device of claim 12, wherein the conducting tracks pass through the at least one insulator.

14. The aerosol generating device of claim 1, further comprising a base plate arranged within the heating chamber; wherein the base plate is moveable along the heating chamber relative to the heating apparatus.

15. The aerosol generating device of claim 14, wherein the heating apparatus extends through a plate opening in the base plate.
